(19) United States
(12) Patent Application Publication
(10) Pub. No.: US 2007/0054688 A1
(43) Pub. Date: Mar. 8, 2007

(54) Mobile terminal for transmitting emergency message and method thereof

(75) Inventors: Sung-Chul Yang, Suwon-si (KR); Hwan-Seog Choi, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/594,317

(22) Filed: Nov. 8, 2006

Related U.S. Application Data
(62) Division of application No. 11/070,432, filed on Mar. 2, 2005.

(30) Foreign Application Priority Data
Mar. 5, 2004 (KR) 2004-15220

(51) Int. Cl. H04Q 7/20

(52) U.S. Cl. 455/521

(57) ABSTRACT

A mobile terminal includes a memory unit for storing a phonebook including at least one telephone number and registering emergency (SOS) phrases and SOS message recipients; a display unit for displaying a picture for SOS message transmission; an audio unit for converting voice data into an audio signal through a speaker and converting an audio signal received through a microphone into voice data; and a controller for constructing an SOS message using the SOS phrases when the SOS message transmission is required and transmitting the SOS message to predetermined telephone numbers registered in the phonebook when there do not exist the SOS message recipients registered in the memory unit.

### PRIORITY

This application is a divisional application of application Ser. No. 11/070,432, filed in the U.S. Patent and Trademark Office on Mar. 2, 2005, and this application claims priority under 35 U.S.C. § 119to an application entitled “Mobile Terminal for Transmitting Emergency Message and Method Thereof” filed in the Korean Intellectual Property Office on Mar. 5, 2004and assigned Ser. No. 2004-15220, the contents of both of which are incorporated herein by reference.

### BACKGROUND OF THE INVENTION

1. Field of the Invention

The present invention relates generally to a mobile terminal, and in particular, to an apparatus and method for transmitting an emergency (SOS) message of reporting an emergency situation of a user in a mobile terminal.

2. Description of the Related Art

With the development of communication technology, the number of subscribers using mobile communication services has dramatically increased. Nowadays, most people have more than one mobile terminal. Accordingly, when a person faces an emergency situation, e.g., occurrence of a traffic accident, breakout of fire, intrusion of a burglar, or encounter with hooligans, the person usually uses a mobile terminal to report the situation and ask for help.

Currently, there are two conventional methods for a user to ask for help using a mobile terminal. According to a first method, the user directly calls a helper using the mobile terminal, explains his/her situation, and asks for help. According to a second method, the user subscribes to a service provided by a mobile communication provider and sends an SOS call to the mobile communication provider. In the second method, when the user sends the SOS call to the mobile communication provider, the mobile communication provider reports the user's situation to persons pre-selected by the user by providing information on the user's current location or still or video images of the current situation to convey the problem and ask for help.

The first method has a disadvantage in that it is troublesome since the user would have to call several persons one by one. In addition, the first method is not viable where the user directly faces an offender, e.g., intrusion of a burglar or encounter with hooligans.

The second method uses a position tracing system, such as a global positioning system (GPS), to report position information or a current situation of the user facing an emergency situation. Accordingly, the second method has a disadvantage because it requires that the user have a mobile terminal with a GPS receiver function and/or a photographic function. The providing of position information, and video capture and transmission features, such as moving pictures, and/or still images is provided independently according to mobile communication providers. Accordingly, the second method is unavailable to users with multiple mobile communication providers because one provider may include GPS, but no video capture and another may include video capture, but no GPS. In this case, the second method is unavailable because both GPS and video capture would be needed from one provider.

### SUMMARY OF THE INVENTION

An object of the present invention is to substantially solve at least the above problems and/or disadvantages and to provide at least the advantages below. Accordingly, an object of the present invention is to provide an apparatus and method for transmitting an emergency (SOS) message to report an emergency situation and ask for relief using a short message function without direct calls.

Another object of the present invention is to provide an apparatus and method for a user to transmit an emergency (SOS) message to report an emergency situation and ask for relief using a short message function embedded in a mobile terminal without subscribing for an additional mobile communication service provided by a mobile communication provider.

A further object of the present invention is to provide an emergency (SOS) message transmitting apparatus and method for reporting a user's emergency situation to a recipient receiving an emergency (SOS) message by automatically connecting a telephone call without any signals indicating an incoming call so that dangerous characters, such as burglars or hooligans, do not recognize the incoming call when there is the incoming call from the SOS message recipient since the user has sent the SOS message.

According to one aspect of the present invention, a mobile terminal includes a memory unit, which stores a phonebook including at least one telephone number and registers emergency (SOS) phrases and SOS message recipients; a display unit, which displays a picture for SOS message transmission; an audio unit, which converts voice data into an audio signal through a speaker and converts an audio signal received through a microphone into voice data; and a controller, which constructs an SOS message using the SOS phrases when the SOS message transmission is required and transmits the SOS message to predetermined telephone numbers registered in the phonebook when there are no SOS message recipients registered in the memory unit.

According to another aspect of the present invention, an emergency (SOS) message transmitting method includes the steps of constructing an SOS message using SOS phrases when a user demands SOS message transmission; and transmitting the SOS message to pre-registered SOS message recipients, and if there are no pre-registered SOS message recipients, transmitting the SOS message to predetermined telephone numbers registered in a phonebook.

According to another aspect of the present invention, a mobile terminal includes a display unit, which displays an emergency (SOS) message received from an SOS message sender; an audio unit, which is connected with a speaker and a microphone, converts voice data into an audio signal through the speaker, and converts an audio signal received through the microphone into voice data; and a controller, which controls the audio unit to block audio signals input through the microphone when a phone call with the SOS message sender is demanded.

According to another aspect of the present invention, a method of receiving an emergency (SOS) message in a mobile terminal includes the steps of receiving the SOS message from an SOS message sender; determining whether a phone call with the SOS message sender is demanded; and if the phone call with the SOS message sender is demanded, blocking audio signals input through a microphone.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a mobile terminal according to a preferred embodiment of the present invention;

FIG. 2 is a flowchart illustrating an SOS message transmission process according to a preferred embodiment of the present invention;

FIG. 3 is a flowchart illustrating an SOS message function setting process according to a preferred embodiment of the present invention;

FIGS. 4A and 4B are examples of an SOS message menu screen according to a preferred embodiment of the present invention;

FIGS. 5A and 5B are examples of an SOS message recipient registering screen and an SOS phrases registering screen according to a preferred embodiment of the present invention;

FIG. 6 is an example of a screen on which an SOS message function setting icon is displayed according to a preferred embodiment of the present invention;

FIG. 7 is a flowchart illustrating an SOS message receiving process according to a preferred embodiment of the present invention; and

FIG. 8 is an example of a screen on which a received SOS message is displayed according to a preferred embodiment of the present invention.

### DETAILED DESCRIPTION OF THE PREFERRED EMBODIMENT

Preferred embodiments of the present invention will be described herein below with reference to the accompanying drawings. In the drawings, the same or similar elements are denoted by the same reference numerals even though they are depicted in different drawings. In the following description, well-known functions or constructions are not described in detail since they would obscure the invention in unnecessary detail.

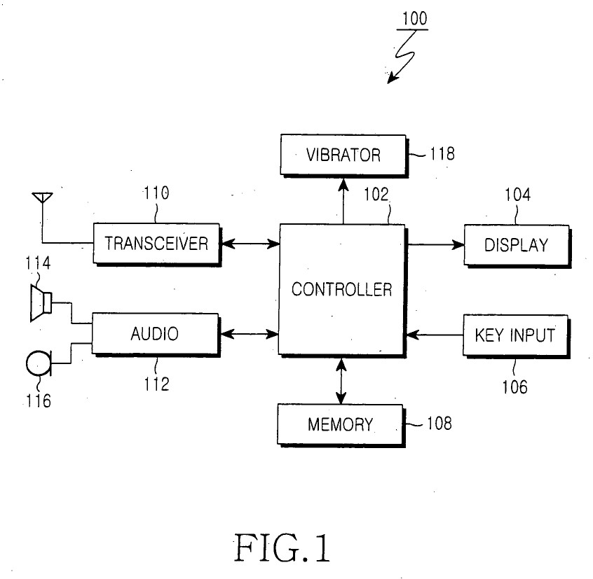

FIG. 1 is a block diagram of a mobile terminal 100 according to a preferred embodiment of the present invention. Referring to FIG. 1, the mobile terminal 100 includes a controller 102, a display unit 104, a key-input unit 106, a memory unit 108, a transceiver 110, an audio unit 112, a speaker 114, a microphone 116, and a vibrator 118.

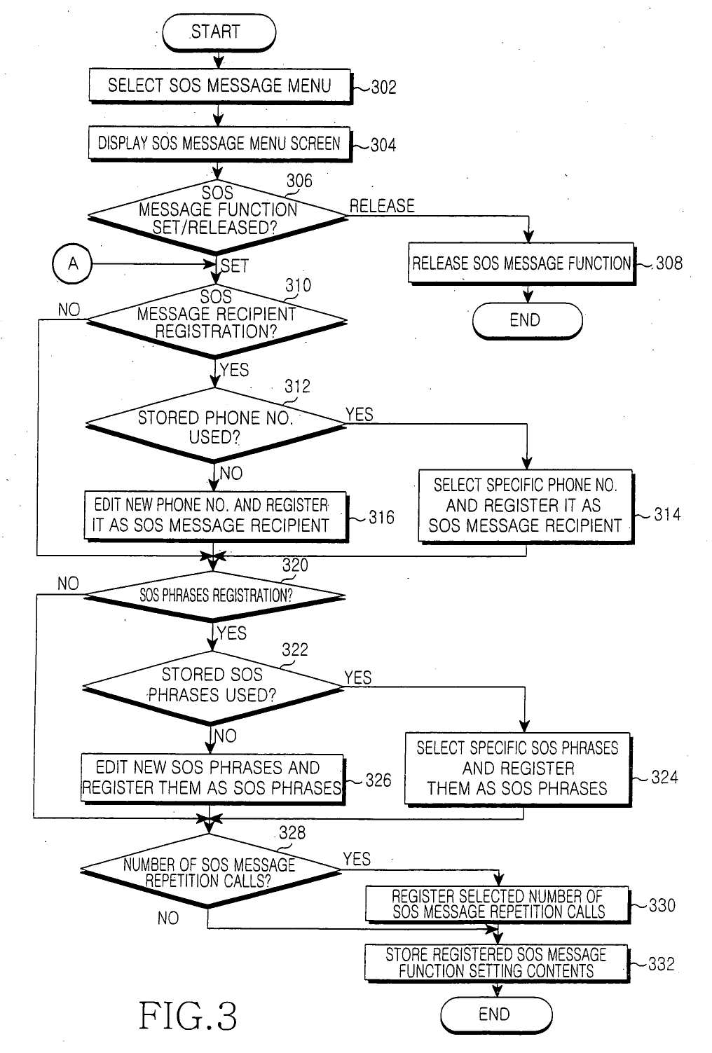

The controller 102 performs a general control operation for emergency (SOS) message transmission according to an embodiment of the present invention. When a user selects an SOS message menu item, the controller 102 displays an SOS message menu screen and sets/releases an SOS message function by interfacing with a user on the SOS message menu screen. When the SOS message function is set, the controller 102 registers SOS message recipients, SOS phrases, and the number of SOS message repetition calls by interfacing with the user. The SOS message function setting process will be described in detail with reference to FIG. 3 below.

When an SOS message transmission request is input by the user, the controller 102 transmits an SOS message and stays in an SOS call waiting mode. When an incoming call from an SOS message recipient is received, the controller 102 controls the incoming call to be automatically connected. When the incoming call is connected with the SOS message recipient in the SOS call waiting mode, the controller 102 controls inputs/outputs of the speaker 114 and the microphone 116 on the basis of an open/closed state of a folder.

The display unit 104 can be made up of a liquid crystal display (LCD) and outputs a variety of display data generated by the mobile terminal 100. The display unit 104 displays the SOS message menu screen for registering the SOS phrases, the SOS message recipients, and the number of SOS message repetition calls in response to a display control signal output from the controller 102. Under the control of the controller 102, the display unit 104 displays an SOS call waiting mode icon indicating that the mobile terminal 100 is in the SOS call waiting mode and displays a transmitting state of the SOS message in a visual pattern such as text or an icon. For example, the display unit 104 displays texts indicating the transmitting state of the SOS message, e.g. “SOS message calling” −>“SOS message transmission succeeded”−>“confirming call//reception waiting.” If the mobile terminal 100 has a backlight, the display unit 104 turns off the backlight in the SOS call waiting mode under the control of the controller 102 in order for offenders, such as burglars or hooligans, not to recognize whether the user operates the mobile terminal 100, e.g., whether the user transmits the SOS message, in a case where the user faces the offenders.

The memory unit 108 can be made up of read only memory (ROM) and random access memory (RAM) and stores program and data for performing the SOS message transmission according to the present embodiment. The memory unit 108 has a region for storing the SOS phrases and at least one SOS message recipient to which the SOS message is transmitted. Here, the SOS phrases and the SOS message recipients may be fixed as pre-stored data or edited by the user.

The transceiver 110 receives a signal generated by the controller 102, performs digital wireless modulation on the received signal, and emits the modulated signal through an antenna. Also, the transceiver 110 demodulates a signal received through the antenna and transmits the demodulated signal to the controller 102. Under the control of the controller 102, the transceiver 110 transmits the SOS message to the pre-registered SOS message recipients or receives a call from the outside including a call from any one of the pre-registered SOS message recipients and transmits the received call to the controller 102.

Under the control of the controller 102, the audio unit 112 converts voice data to an audio signal and outputs the audio signal through the speaker 114 for the user to hear. Also, under the control of the controller 102, the audio unit 112 converts an audio signal received from the microphone 116 to audio data and outputs the converted audio data to the controller 102. In the SOS call waiting mode, the audio unit 112 stops an audio signal output operation for informing the user of a call connection request from the outside, short message arrival, or any other alarm operation under the control of the controller 102.

In a state where a folder-type cell phone is closed, if a call is connected with a SOS message recipient in the SOS call waiting mode, under the control of the controller 102, the audio unit 112 stops outputting an audio signal through the speaker 114 and only converts an audio signal input from the microphone 116 to voice data. When the folder is open, if a call is connected with a SOS message recipient in the SOS call waiting mode, under the control of the controller 102, the audio unit 112 outputs an audio signal through the speaker 114 in a minimum volume level and converts an audio signal input from the microphone 116 to voice data. In this manner, when a call is connected with a SOS message recipient, the SOS recipient can hear what is going on in the emergency situation, but the offenders cannot hear the SOS recipient and thus prevents alerting the offenders to the SOS call.

The key-input unit 106 is a device for interfacing with the user and includes various function (e.g., camera and speaker volume control) keys, a plurality of keys for calling or message inputting, and an SOS message transmission key. The SOS message transmission key included in the key-input unit 106 can be realized with a separate button or used by newly defining a button assigned for another function as a button for transmitting the SOS message. For example, the SOS message transmission key can be used by defining an action of pushing a speaker volume up/down key for more than several seconds or consecutively several times as an input for transmitting the SOS message. When the SOS message transmission key is activated by the user, the key-input unit 106 transmits an SOS message transmission request input signal to the controller 102. The controller 102, then controls the vibrator 118 to vibrate slightly or vibrates a predetermined number of times, i.e., three times, in order to inform the user of the signal reception.

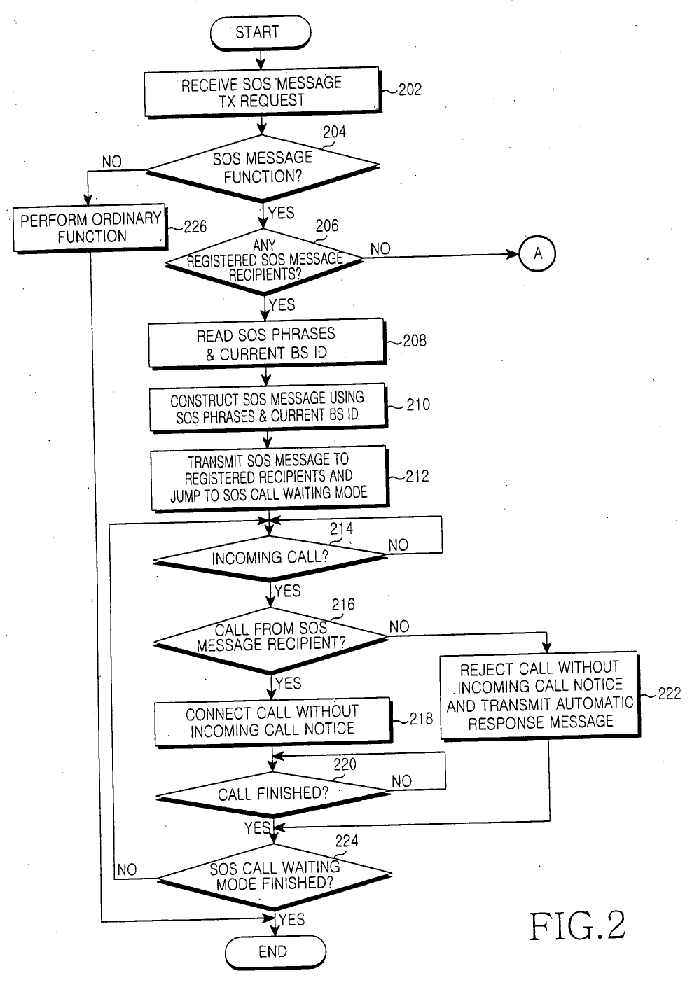

FIG. 2 is a flowchart illustrating an SOS message transmission process according to a preferred embodiment of the present invention. The SOS message transmission process will now be described in detail with reference to FIGS. 1 and 2.

If an SOS message transmission request is activated by a user in step 202, the controller 102 determines whether the SOS message function is set in step 204.

If the SOS message function is not set, the controller 102 ignores the SOS message transmission request input and performs ordinary processes in step 226. If the SOS message function is set, the controller 102 determines whether there exist pre-registered SOS message recipients in step 206. If there exist no pre-registered SOS message recipients, the controller 102 can be configured to temporarily set a specific phone number registered in a phonebook, e.g., a phone number corresponding to an address 0 of the phonebook or a short number 0, to a SOS message recipient. Alternatively, the SOS message recipients can be assigned to a specific group stored in the phonebook. For example, the SOS message can be transmitted to all of phone numbers stored in a group “family”of the phonebook. In a further alternative method, the SOS message recipients can be specific phone numbers, e.g., 119 and/or 112 in Korea, or 911 in the U.S. The specific phone numbers in the phonebook used for the SOS message recipients may be set in a manufacturing process of the mobile terminal 100 or set by the user.

If there exist pre-registered SOS message recipients in step 206, the controller 102 turns the mobile terminal 100 into an SOS mode and reads the SOS phrases and current position information of the mobile terminal 100 in step 208. Here the SOS phrases can be stored in the manufacturing process of the mobile terminal 100 or edited, registered, and stored by the user. Base station identification information is preferably used for the position information of the mobile terminal 100. The base station identification information is a value pre-stored in the mobile terminal 100 to communicate with a base station, and if a currently communicating base station is changed, current base station identification information is also changed.

After reading the SOS phrases and the current base station identification information, the controller 102 constructs the SOS message using the SOS phrases and the current base station identification information in step 210. Here, the SOS message further includes therein a sender phone number and an SOS message identification code. The SOS message identification code is used for informing that the corresponding message is the SOS message, and a special character code can be used as the SOS message identification code.

In step 212, the controller 102 transmits the SOS message to the SOS message recipients and jumps to the SOS call waiting mode. Here, the SOS message recipients can be more than one in number. When there exist a plurality of the SOS message recipients, the controller 102 transmits the SOS message to the plurality of SOS message recipients in order. If an error in transmission to a certain recipient occurs during the transmission of the SOS message, the controller 102 does not immediately retransmit the SOS message to the error-occurred recipient, but rather, after transmitting the SOS message to the next recipient, the controller 102 tries to retransmit the SOS message to the error-occurred recipient.

Even if an incoming call is received from a predetermined SOS message recipient during the transmission of the SOS message, the controller 102 continuously transmits the SOS message separate from the incoming call receiving operation. If the number of repeated calls of the SOS message is set to 1 or larger, the controller 102 transmits the SOS message to more than one SOS message recipient in order and repeatedly transmits the SOS message as many times as the set number of repeated calls. For example, the number of repeated calls of the SOS message is set to 3, the controller 102 transmits the SOS message to more than one SOS message recipient in order and transmits the SOS message in the same way two more times. If the SOS message transmission request is input in a no-service area, the controller 102 displays a message indicating no service area and controls the SOS message to be transmitted as soon as the mobile terminal 100 goes into a service area.

In the SOS call waiting mode, the controller 102 displays a pre-set SOS call waiting mode icon on the display unit 104 and displays a transmitting state of the SOS message in a visual pattern such as text or an icon, and when the mobile terminal 100 has a backlight, the backlight is turned off. In the SOS call waiting mode, the controller 102 stops all audio signal output operations for informing the user of a call connection request from the outside, short message arrival, and any other alarm operation. In the SOS call waiting mode, the controller 102 determines whether an incoming call is received in step 214. If the incoming call is received from the outside through the transceiver 110, the controller 102 determines whether the incoming call is received from any one of the SOS message recipients in step 216. That is, the controller 102 determines whether the incoming call is received from any one of the SOS message recipients by detecting the sender of the incoming call.

If the incoming call is received from any one of the SOS message recipients, the controller 102 automatically connects the call without an incoming call notice in step 218. Here, if the folder is closed, no audio signals are sent through the speaker 114, and only audio signals from the microphone 116 are input. If the folder is open, both of output of audio through the speaker 114 and input of audio signals from the microphone 116 are normally performed. The audio signal through the speaker 114 is preferably output in a minimum volume level. The controller 102 determines whether the call connection with the SOS message recipient is finished in step 220. If the call connection with the SOS message recipient is finished by a call-end-key input by the user, the controller 102 goes to step 224.

If the incoming call is received from an unexpected sender who is not any one of the SOS message recipients, in step 222, the controller 102 performs a call reject operation without an incoming call notice and transmits an automatic response message for informing the unexpected sender of the emergency situation. Here, the automatic response message indicating the emergency situation may be a message such as “please report to a police/fire station that the user faces an emergency situation.”

The controller 102 determines whether the SOS call waiting mode is finished in step 224. If a key corresponding to ending of the SOS call waiting mode is input by the user, the controller 102 finishes the SOS call waiting mode. If the key corresponding to ending of the SOS call waiting mode is not input, the controller 102 goes to step 214 and maintains the SOS call waiting mode.

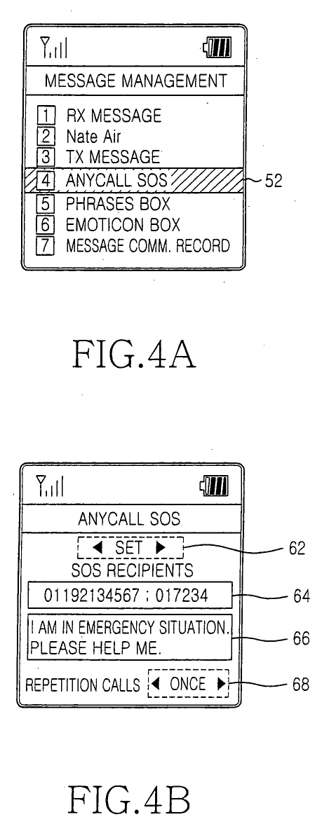

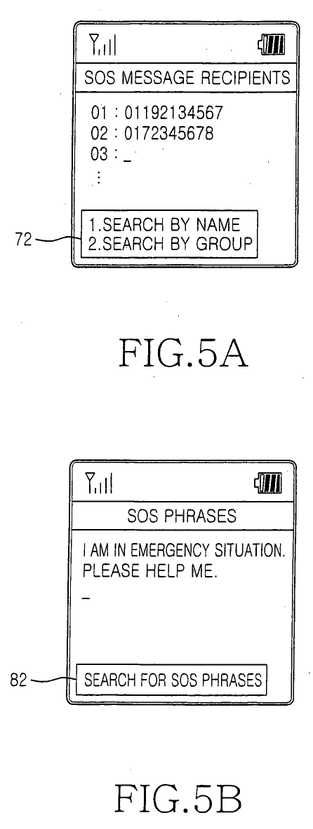

FIG. 3 is a flowchart illustrating an SOS message function setting process according to a preferred embodiment of the present invention. FIGS. 4A and 4B are examples of the SOS message menu screen according to a preferred embodiment of the present invention. FIGS. 5A and 5B are examples of a screen for registering SOS message recipients and an SOS message according to a preferred embodiment of the present invention.

The SOS message function setting process will now be described in detail with reference to FIGS. 1 through 5.

If selection of an SOS message menu item is activated by the user using the key-input unit 106 in step 302, the controller 102 displays the SOS message menu screen in step 304. For example, FIG. 4A shows a message management menu screen, and FIG. 4B shows a screen when an “Anycall SOS” menu item, which is the SOS message menu item within message management menu items, is selected. If the user selects the “Anycall SOS” menu item, which is the SOS message menu item, on the message management menu screen shown in FIG. 4A, the controller 102 displays an “Anycall SOS” menu screen, which is the SOS message menu screen shown in FIG. 4B. Referring to FIG. 4B, items for setting the SOS message function are displayed on the SOS message menu screen.

The items for setting the SOS message function may include an SOS message set/release selection item 62, an SOS message recipient registering item 64, an SOS phrases registering item 66, and an SOS message repetition calls registering item 68. The SOS message set/release selection item 62 is an item for selecting whether to set or release the SOS message function. The SOS message recipient registering item 64 is an item for registering SOS message recipients. The SOS phrases registering item 66 is an item for registering the SOS phrases. The SOS message repetition calls registering item 68 is an item for registering the number of SOS message repetition calls for determining how many times the SOS message is repeatedly transmitted.

After displaying the SOS message menu screen including items for setting the SOS message function described above, the controller 102 determines whether “SOS message function set/release” is selected in step 306. For example, if “RELEASE” is selected in the SOS message set/release selection item 62 shown in FIG. 4B, the controller 102 determines that the SOS message function is released, and if “SET” is selected in the SOS message set/release selection item 62 shown in FIG. 4B, the controller 102 determines that the SOS message function is set. If the SOS message function release is selected, the controller 102 releases the SOS message function in step 308.

If the SOS message function set is selected, the controller 102 determines whether “SOS message recipient registering” is selected in step 310. For example, if the SOS message recipient registering item 64 on the SOS message menu screen shown in FIG. 4B is selected by the user, the controller 102 displays an SOS message recipient registering screen for registering the SOS message recipients. FIG. 5A is an example of the SOS message recipient registering screen. Referring to FIG. 5A, if an item of a menu 72, such as “1. SEARCH BY NAME” or “2. SEARCH BY GROUP,” is selected on the SOS message recipient registering screen shown in FIG. 5A, the controller 102 determines that an SOS message recipient is registered using a stored phone number in step 312. The controller 102 selects a specific phone number. from stored phone numbers and registers the selected phone number as the SOS message recipient in step 314. Here, the controller 102 can select at least two of the stored phone numbers and register the selected phone numbers as the SOS message recipients.

If stored phone numbers are not used, the controller 102 edits a new phone number on the SOS message recipient registering screen shown in FIG. 5A by interfacing with the user and registers the edited new phone number as an SOS message recipient in step 316. Here, the controller 102 can edit at least one new phone number(s) and register the edited phone number(s) as the SOS message recipient(s). Also, the controller 102 can assign priorities to the SOS message recipients when the SOS message recipients are registered by the stored phone number selection or the new phone number editing. When the SOS message recipients are assigned priorities, the controller 102 will transmit the SOS message in the order of recipient priority from highest to lowest.

The controller 102 determines whether “SOS phrases registering” is selected in step 320. For example, if the SOS phrases registering item 66 on the SOS message menu screen shown in FIG. 4B is selected by the user, the controller 102 displays an SOS phrases registering screen for registering the SOS phrases. FIG. 5B is an example of the SOS phrases registering screen. Referring to FIG. 5B, if a menu 82, such as “SEARCH FOR SOS PHRASES,” for using stored SOS phrases is selected, the controller 102 determines that the stored SOS phrases are used in step 322. The controller 102 selects specific SOS phrases of the stored SOS phrases and registers the selected SOS phrases as the SOS phrases in step 324.

If the stored SOS phrases are not used, the controller 102 edits new SOS phrases on the SOS phrases registering screen shown in FIG. 5B by interfacing with the user and registers the edited new SOS phrases as SOS phrases in step 326.

The controller 102 determines whether “the number of SOS message repetition calls” is selected in step 328. For example, if the number of SOS message repetition calls is selected by the user using the SOS message repetition calls registering item 68 on the SOS message menu screen shown in FIG. 4B, the controller 102 registers the selected number of SOS message repetition calls in step 330.

After registering the SOS message recipients, the SOS phrases, and the number of SOS message repetition calls as described above, the controller 102 stores the registered SOS message function setting contents in the memory unit 108 in step 332 and finishes the SOS message function setting process. The controller 102 displays an icon indicating that the SOS message function is set.

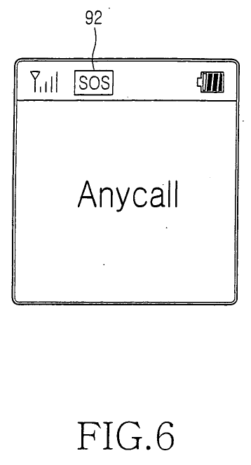

FIG. 6 is an example of a screen on which an SOS message function setting icon 92 is displayed according to a preferred embodiment of the present invention. Referring to FIG. 6, an idle screen on which the SOS message function setting icon 92, such as “SOS,” is displayed is shown. The user can easily recognize whether the SOS message function is in a set state or in a released state based on the SOS message function setting icon 92.

A configuration and operation of an SOS message recipient terminal according to a preferred embodiment of the present invention will now be described. In this embodiment, the SOS message recipient terminal is not separately classified, and the mobile terminal of FIG. 1 performs functions of the SOS message recipient terminal.

Referring to FIG. 1, if a message is received from the outside, the controller 102 analyzes the received message and determines whether the received message is a general message or an SOS message. If the received message is the general message, the controller 102 informs the user of the reception of the general message in a general message reception informing method, and if the received message is the SOS message, the controller 102 informs the user of the reception of the SOS message in a SOS message reception informing method.

The transceiver 110 receives a call, such as a message, from the outside, transmits the call to the controller 102, and transmits a call connection request signal to the outside under the control of the controller 102. The display unit 104 displays the SOS message in response to a display control signal output from the controller 102.

Under the control of the controller 102, the audio unit 112 converts voice data to an audio signal and outputs the audio signal through the speaker 114 for the user to hear. Also, under the control of the controller 102, the audio unit 112 converts audio signals received from the microphone 116 to audio data and outputs the converted audio data to the controller 102. The controller 102 tries a call to an SOS message sender after receiving the SOS message, and if the call is connected, the controller 102 controls the audio unit 112 and the microphone 116 so that audio is not transmitted from the SOS message recipient to the SOS message sender.

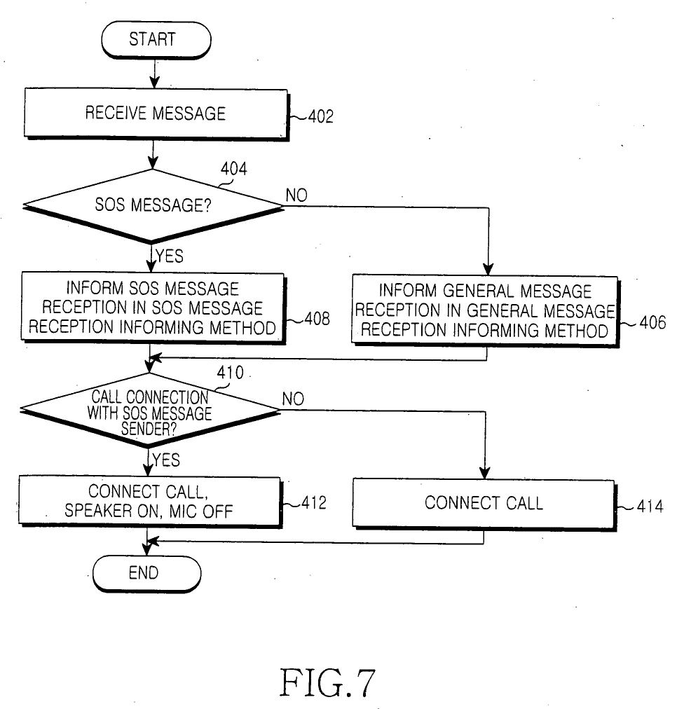

FIG. 7 is a flowchart illustrating an SOS message receiving process according to a preferred embodiment of the present invention.

The process for an SOS message recipient terminal receiving an SOS message and informing a user of the SOS message reception will now be described in detail with reference to FIGS. 1 and 7.

If a message is received through the transceiver 110 in step 402, the controller 102 determines whether the received message is an SOS message in step 404. Here, the controller 102 analyzes the received message and determines whether a special character code indicating the SOS message is included in the received message. If the special character code indicating the SOS message is included in the received message, the controller 102 determines that the received message is an SOS message, and if the special character code indicating the SOS message is not included in the received message, the controller 102 determines that the received message is a general message. As a result of the determination, if the received message is not an SOS message, the controller 102 informs a user of reception of the general message in the general message reception informing method in step 406. That is, the controller 102 outputs a general message reception notice sound and displays the general message through the display unit 104.

If the received message is an SOS message, the controller 102 informs the user of reception of the SOS message in the SOS message reception informing method in step 408. That is, regardless of the pre-set general message reception informing method, the controller 102 outputs an SOS message reception notice sound and displays the SOS message through the display unit 104.

The SOS message reception informing method can be a method of outputting the SOS message reception notice sound at the maximum volume regardless of a pre-set magnitude of a bell sound for general messages. Alternatively, the SOS message reception informing method can be a method of outputting a newly set SOS message reception notice sound, e.g., a siren, regardless of a pre-set bell sound type for general messages. Here, when the user has specified general message reception informing intervals as none or once, the controller 102 outputs the SOS message reception notice sound at the maximum volume once. When the user has specified the general message reception informing intervals as every two minutes, the controller 102 outputs the SOS message reception notice sound at the maximum volume every two minutes.

If the user is on another call when the SOS message is received, the controller 102 outputs the SOS message reception notice sound at a low volume. If the mobile terminal is in a browser operating, modem communicating, or additional service operating state when the SOS message is received, the controller 102 outputs the SOS message reception notice sound and simultaneously displays the SOS message reception icon for informing the user of the SOS message reception.

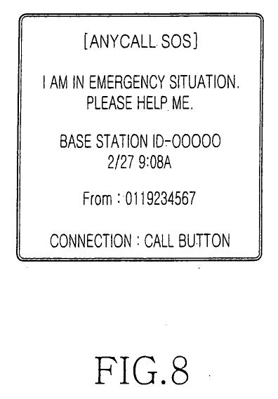

FIG. 8 is an example of a screen on which the received SOS message is displayed according to a preferred embodiment of the present invention. Referring to FIG. 8, when the controller 102 displays the SOS message through the display unit 104, the controller 102 displays “[Anycall SOS],” which is a title for indicating the SOS message, “I am in an emergency situation. Please, help me.”, which is SOS phrases, “Base station ID-00000,” which is a base station identification number of an SOS message sender, “2/27 9:08A,” which is an SOS message transmitting date and time, “From: 0119234567,” which is a telephone number of the SOS message sender, and “Connection: Call button,” which is a method for connecting with the SOS message sender.

After informing the user of the SOS message reception as described above, the controller determines whether the user requests a call connection with the SOS message sender in step 410. If the call connection with the SOS message sender is requested, in step 412, the controller 102 turns the microphone 116 off and the speaker 114 on in order to transmit audio from the emergency situation to the SOS message recipient while offenders, such as burglars or robbers, close to the SOS message sender will not be able to hear any indication that an SOS message was sent. Here, the microphone 116 may be configured to be inactivated (off) only for a first transmission to the SOS message sender and be activated (on) after a second transmission.

If the call connection with the SOS message sender is not requested, the controller 102 performs the call connection in a typical method in step 414.

As described above, in the inventive apparatus and method, when a user faces an emergency situation, the user can transmit an emergency (SOS) message to a plurality of people at once and ask for relief using a short message function without directly calling the plurality of people one by one or subscribing for additional mobile communication services.

Also, by automatically connecting an incoming call without indicating the incoming call when it is from the SOS message recipient, the user can safely inform the SOS message recipient of the user's situation without informing dangerous people, such as burglars or hooligans, of the incoming call.

Also, when an incoming call is received from an unexpected person who is not an SOS message recipient after the user has transmitted the SOS message, the user can transmit the SOS message to the unexpected person and ask for help using an automatic response function without being notified of the incoming call.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A mobile terminal, comprising:
a transceiver for receiving an external message and transmitting a call connection request signal;
a display unit for displaying the received message;
an audio unit for outputting a general message reception informing sound under a control and outputting an SOS message reception informing sound; and
a controller for determining whether the received message is a general message or an SOS message, informing a user of a reception of the general message in a general message reception informing method pre-set by a user and displaying the received general message if the received message is not the SOS message, and informing the user of a reception of the SOS message in an SOS message reception informing method and displaying the received the SOS message if the received message is the SOS message.

2. The mobile terminal of claim 1, wherein the SOS message includes an SOS message identification code, SOS phrases, position information of the SOS message sender, and a phone number of the SOS message sender.

3. The mobile terminal of claim 1, wherein the controller determines whether the received message is the SOS message based on whether an SOS message identification code is included in the received message.

4. The mobile terminal of claim 1, wherein the controller informs the SOS message recipient by a bell sound at maximum volume.

5. The mobile terminal of claim 2, wherein the controller informs the SOS message recipient by a bell sound at maximum volume.

6. The mobile terminal of claim 3, wherein the controller informs the SOS message recipient by a bell sound at maximum volume.

7. The mobile terminal of claim 1, wherein the SOS message reception informing method is a method of outputting a pre-set SOS message informing sound.

8. The mobile terminal of claim 2, wherein the SOS message reception informing method is a method of outputting a pre-set SOS message informing sound.

9. The mobile terminal of claim 3, wherein the SOS message reception informing method is a method of outputting a pre-set SOS message informing sound.

10. The mobile terminal of claim 1, wherein the SOS message reception informing method is a method of outputting the SOS message reception informing sound regardless of whether a mute mode is set in the mobile terminal.

11. The mobile terminal of claim 2, wherein the SOS message reception informing method is a method of outputting the SOS message reception informing sound regardless of whether a mute mode is set in the mobile terminal.

12. The mobile terminal of claim 3, wherein the SOS message reception informing method is a method of outputting the SOS message reception informing sound regardless of whether a mute mode is set in the mobile terminal.

13. A method for receiving a SOS message in a mobile terminal, comprising the steps of:
(a) determining, when a message is received, whether the received message is an SOS message;
(b) informing a user, if the received message is not the SOS message, of a reception of a general message in a general message reception informing method pre-set by a user and displaying the received general message; and
(c) informing the user, if the received message is the SOS message, of a reception of the SOS message in an SOS message reception informing method and displaying the received SOS message.

14. The method of claim 13, wherein the SOS message includes an SOS message identification code, SOS phrases, position information of the SOS message sender, and a phone number of the SOS message sender.

15. The method of claim 13, further comprising (d) determining, when a message is received, whether the received message is the SOS message based on whether an SOS message identification code is included in the received message.

16. The method of claim 13, wherein the SOS message reception informing method is a method of outputting a bell sound pre-set as a general message reception informing sound at maximum volume.

17. The method of claim 14, wherein the SOS message reception informing method is a method of outputting a bell sound pre-set as a general message reception informing sound at maximum volume.

18. The method of claim 15, wherein the SOS message reception informing method is a method of outputting a bell sound pre-set as a general message reception informing sound at maximum volume.

19. The method of claim 13, wherein the user is informed by an SOS message reception informing sound regardless of whether a mute mode is set in the mobile terminal.

20. The method of claim 14, wherein the user is informed by an SOS message reception informing sound regardless of whether a mute mode is set in the mobile terminal.

21. The method of claim 15, wherein the user is informed by an SOS message reception informing sound regardless of whether a mute mode is set in the mobile terminal.

22. A mobile terminal, comprising:
a transceiver for receiving an external message and transmitting a call connection request signal;
a display unit for displaying the received message;
an audio unit for outputting a general message reception informing sound under a control and outputting an SOS message reception informing sound; and
a controller for determining whether the received message is a general message or an SOS message, informing a user of a reception of the general message in a general message reception informing method pre-set by a user and displaying the received general message if the received message is not the SOS message, informing the user of a reception of the SOS message in an SOS message reception informing method and displaying the received SOS message if the received message is the SOS message, and controlling the audio unit to block audio signals input through a microphone when a phone call with an SOS message sender is requested.

23. The mobile terminal of claim 22, wherein the SOS message includes an SOS message identification code, SOS phrases, position information of the SOS message sender, and a phone number of the SOS message sender.

24. The mobile terminal of claim 22, wherein the controller determines whether the received message is the SOS message based on whether an SOS message identification code is included in the received message.

25. The mobile terminal of claim 22, wherein the controller informs the SOS message recipient by a bell sound at maximum volume.

26. The mobile terminal of claim 23, wherein the controller informs the SOS message recipient by a bell sound at maximum volume.

27. The mobile terminal of claim 24, wherein the controller informs the SOS message recipient by a bell sound at maximum volume.

28. The mobile terminal of claim 22, wherein the SOS message reception informing method is a method of outputting a pre-set SOS message informing sound.

29. The mobile terminal of claim 23, wherein the SOS message reception informing method is a method of outputting a pre-set SOS message informing sound.

30. The mobile terminal of claim 24, wherein the SOS message reception informing method is a method of outputting a pre-set SOS message informing sound.

31. The mobile terminal of claim 22, wherein the SOS message reception informing method is a method of outputting an SOS message reception informing sound regardless of whether a mute mode is set in the mobile terminal.

32. The mobile terminal of claim 23, wherein the SOS message reception informing method is a method of outputting an SOS message reception informing sound regardless of whether a mute mode is set in the mobile terminal.

33. The mobile terminal of claim 24, wherein the SOS message reception informing method is a method of outputting an SOS message reception informing sound regardless of whether a mute mode is set in the mobile terminal.

34. A method for receiving an SOS message in a mobile terminal, comprising the steps of:
(a) determining, when a message is received, whether the received message is the SOS message;
(b) informing a user, if the received message is not the SOS message, of a reception of a general message in a general message reception informing method pre-set by a user and displaying the received general message; and
(c) informing the user, if the received message is the SOS message, of a reception of the SOS message in an SOS message reception informing method and displaying the received SOS message.
(d) controlling the audio unit to block audio signals input through a microphone when a phone call with an SOS message sender is requested.

35. The mobile terminal of claim 34, wherein the SOS message includes an SOS message identification code, SOS phrases, position information of the SOS message sender, and a phone number of the SOS message sender.

36. The mobile terminal of claim 34, wherein the controller determines whether the received message is the SOS message based on whether an SOS message identification code is included in the received message.

37. The mobile terminal of claim 34, wherein the controller informs the SOS message recipient by a bell sound at maximum volume.

38. The mobile terminal of claim 35, wherein the controller informs the SOS message recipient by a bell sound at maximum volume.

39. The mobile terminal of claim 36, wherein the controller informs the SOS message recipient by a bell sound at maximum volume.

40. The mobile terminal of claim 34, wherein the SOS message reception informing method is a method of outputting a pre-set SOS message informing sound.

41. The mobile terminal of claim 35, wherein the SOS message reception informing method is a method of outputting a pre-set SOS message informing sound.

42. The mobile terminal of claim 36, wherein the SOS message reception informing method is a method of outputting a pre-set SOS message informing sound.

43. The mobile terminal of claim 34, wherein the SOS message reception informing method is a method of outputting an SOS message reception informing sound regardless of whether a mute mode is set in the mobile terminal.

44. The mobile terminal of claim 35, wherein the SOS message reception informing method is a method of outputting an SOS message reception informing sound regardless of whether a mute mode is set in the mobile terminal.

45. The mobile terminal of claim 36, wherein the SOS message reception informing method is a method of outputting an SOS message reception informing sound regardless of whether a mute mode is set in the mobile terminal.
